(19) United States
(12) Patent Application Publication
(10) Pub. No.: US 2005/0097811 A1
(43) Pub. Date: May 12, 2005

(54) Bait dispenser

(76) Inventor: Dale Scribner, Sacramento, CA (US)

Correspondence Address: Kelly McCrystle;McCrystle & Associates, P.O. Box 848, Belmont, CA, 94002, US

(21) Appl. No.: 10/950,607

(22) Filed: Sep. 27, 2004

Related U.S. Application Data
(60) Provisional application No. 60/519,206, filed on Nov. 12, 2003.

(51) Int. Cl. A01M 1/20

(52) U.S. Cl. 43/131

(57) ABSTRACT

In accordance with the present invention there is provided a bait station for dispensing liquid bait, wherein the bait station includes a generally circular bait station formed of two generally planer members spaced apart forming an annular space. Liquid bait is disposed between the two planer members within the annular space, wherein the liquid bait is retained within the annular space by capillary action and fluid forces. In a preferred embodiment the bait station is constructed of a generally opaque material wherein the user can readily determine the amount of liquid bait within the bait station. The bait station may further include a RFID tag and/or a transmitter to track placement of the bait station.

### PRIORITY CLAIM

The present application claims priority to U.S. Provisional Patent Application having Ser. No. 60/519,206 filed on Nov. 12, 2003 the entirety of which is herein incorporated by reference.

### TECHNICAL FIELD

The present invention relates to pest control devices. In particular, it relates to re-usable pesticide dispensers for indoor or outdoor use and which are suitable for liquid pesticides.

### BACKGROUND OF THE INVENTION

The treatment of pest problems has produced a number of devices that are designed to control insect pests. Several approaches have been taken in the design of these devices. These approaches include traps to catch the pest and retain the pest within the trap, and bait stations that are designed to provide a feeding station that contains pesticides wherein the pest consumes and/or carries back to the colony.

Trap devices can be based on adhesive traps which contain a scent lure. An insect is attracted by the scent, enters the trap, and becomes stuck on the adhesive and dies. The common feature of traps is that the insect is killed at the trap. A disadvantage associated with this type of device is that numerous dead insects accumulate which the user must dispose of.

Bait stations differ from trap devices in that the insect is not killed at the bait station. Instead, bait, which is poisoned with pesticide, is provided for consumption by the insect. The insect enters the bait station, devours the bait, exits the bait station, and dies elsewhere. Bait stations of this type can have solid or liquid bait. Bait stations do not result in accumulation of dead insects at the bait station which was a problem created by the traps discussed above. An advantage of bait station over a trap is that when the insect leaves the bait station, it returns to its nest where it can transfer food to other members of the colony who also die from the pesticide they ingest. Several insects may eventually be killed due to the bait brought back to the colony by a single insect. As a result, bait stations may be more effective than trap devices due to their ability to kill insects which have never entered the bait station.

A drawback associated with bait stations is that they are typically self-contained disposable devices. As a result, they tend to be more expensive since the entire device must be replaced whenever the bait is consumed or no longer effective. Due to this, the use of bait is more expensive than it needs to be. It would be desirable to have a self-contained reusable bait station that could be easily refilled when necessary.

Most bait stations are designed for solid bait, while solid bait stations can be prepackaged, a prepackaged liquid bait station would be difficult to produce and transport without spilling the bait. As a result, it would be desirable to produce a bait station that utilizes liquid bait, wherein the end user assembles the bait station.

Another problem associated with a liquid bait station is that once the bait station is filled with liquid bait the user must be careful not to disturb the bait station as any motion may result in spilled bait. Therefore there is a need for a bait station that utilizes the principles of fluidics to retain the liquid bait.

While addressing the basic desirability of using bait stations, the prior art has failed to provide a reusable bait station which is inexpensive to manufacture, which has a minimum number of components, which allows easy refilling, which can be used with liquid bait, which reduces the possibility of bait spilling due to external forces.

### SUMMARY OF THE INVENTION

The present invention provides a bait station, the bait station comprising: a first member; a second member; and a support column disposed between and spacing apart the first and second members thereby defining an annular space between the first and second members, wherein one of the first and second members includes at least one aperture formed therethough and in communication with the annular space.

It is an object of the present invention to provide a bait station that is capable of dispensing liquid bait, wherein the bait station may be re-useable.

It is a further object of the present invention to provide a re-usable bait station which utilizes liquid bait, wherein a user may readily determine the amount of bait remaining within the dispenser easily.

It is a further object of the present invention to provide a device for dispensing liquid bait, wherein the device is configured to reduce evaporation of the liquid bait.

In accordance with the present invention there is provided a bait station kit, the kit comprising: a bait station and a bottle of liquid bait.

In accordance with the present invention there is provided a bait station for dispensing liquid bait, the bait station comprising, at least two generally planer members spaced apart to form an annular space between said members, and at least one aperture formed within one of the generally planer members, wherein the aperture is in fluid communication with the annular space.

### BRIEF DESCRIPTION OF THE FIGURES

To facilitate understanding, the same reference numerals have been used (where practical) to designate similar elements that are common to the Figures. Some such numbering has, however, been omitted for the sake of drawing clarity.

FIG. 1 is a side view of an exemplary embodiment of the bait station in accordance with the present invention.

FIG. 2 is a top view of an exemplary embodiment of the bait station in accordance with the present invention.

FIG. 3 is a plan view of the illustrating the bait station in accordance with the present invention, wherein liquid bait is added to the bait station.

FIG. 4 is a plan view of an alternative embodiment of the bait station in accordance with the present invention.

FIG. 5 is a side view of a base assembly in accordance with the present invention.

FIG. 6 is a side view of an alternative embodiment of the bait station in accordance with the present invention.

### DETAILED DESCRIPTION OF THE PREFERRED EMBODIMENTS

Before the present invention is described in such detail, it is to be understood that this invention is not limited to particular variations set forth herein as various changes or modifications may be made to the invention described and equivalents may be substituted without departing from the true spirit and scope of the invention. In addition, many modifications may be made to adapt a particular situation, material, composition of matter, process, process act(s) or step(s) to the objective(s), spirit or scope of the present invention. All such modifications are intended to be within the scope of the claims made herein.

Methods recited herein may be carried out in any order of the recited events which is logically possible, as well as the recited order of events. Furthermore, where a range of values is provided, it is understood that every intervening value, between the upper and lower limit of that range and any other stated or intervening value in that stated range is encompassed within the invention. Also, it is contemplated that any optional feature of the inventive variations described may be set forth and claimed independently, or in combination with any one or more of the features described herein.

All existing subject matter mentioned herein (e.g., publications, patents, patent applications and hardware) is incorporated by reference herein in its entirety except insofar as the subject matter may conflict with that of the present invention (in which case what is present herein shall prevail). The referenced items are provided solely for their disclosure prior to the filing date of the present application. Nothing herein is to be construed as an admission that the present invention is not entitled to antedate such material by virtue of prior invention.

Reference to a singular item, includes the possibility that there are plural of the same items present. More specifically, as used herein and in the appended claims, the singular forms “a,” “and,” “said” and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation. Last, it is to be appreciated that unless defined otherwise, all technical and scientific terms used herein have the same meaning as commonly understood by one of ordinary skill in the art to which this invention belongs.

In accordance with the present invention there is provided a bait station, wherein the bait station is configured to be utilized with liquid bait. The bait station comprises two generally planer members spaced apart by a support column, thereby forming a space therebetween. Liquid bait may then be disposed within the space, wherein the liquid bait is accessible to pests about the perimeter of the planer members.

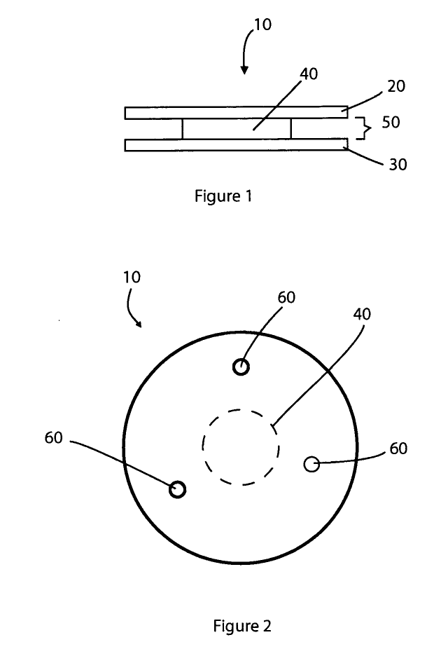

Referring now to FIG. 1, there is shown an exemplary embodiment of the bait station in accordance with the present invention. As shown in FIG. 1 the bait station 10 includes two generally circular members 20 and 30, wherein each member is spaced apart from one another by a support column 40. As shown in FIG. 1, each of the generally circular members includes a first surface and a second surface, wherein the support column 40 is disposed between the second surfaces of each of the members, thereby defining an annular space 50 therebetween.

Referring now to FIG. 2, there is shown a top view of an exemplary embodiment of the bait station in accordance with the present invention. As shown in FIG. 2, the bait station 10 further includes at least one aperture formed in one of the generally circular members, wherein the apertures are in fluid communication with the annular space 50.

As shown in FIGS. 1 and 2, the first and second members are preferably constructed having a generally circular shape it is contemplated that the first and second members may be constructed having other geometric shapes. In a preferred embodiment, the first member, second member and the support column are constructed as a unitary member. The bait station may be constructed as a unitary member through the use of injection molding, machining, casting or similar processes. Although the present invention is described as being constructed of a single member it is contemplated that the bait station of the present invention may be constructed of multiple pieces and assembled into a unitary body.

The bait station in accordance with the present invention is preferably constructed of a generally opaque material. By constructing the bait station of a generally opaque material the user may easily and readily determine the amount of liquid bait in the station by simply looking through the first member. Suitable materials include plastics, ceramics or similar materials. Though it is contemplated that the present invention may be constructed of alternative materials such as metal, wherein the bait station would not be opaque. Further still, the bait station may be constructed of materials having various colors, thereby allowing the bait station to further blend into the environment. For example, if the bait station were to be utilized on a concrete surface it could be molded of a gray plastic.

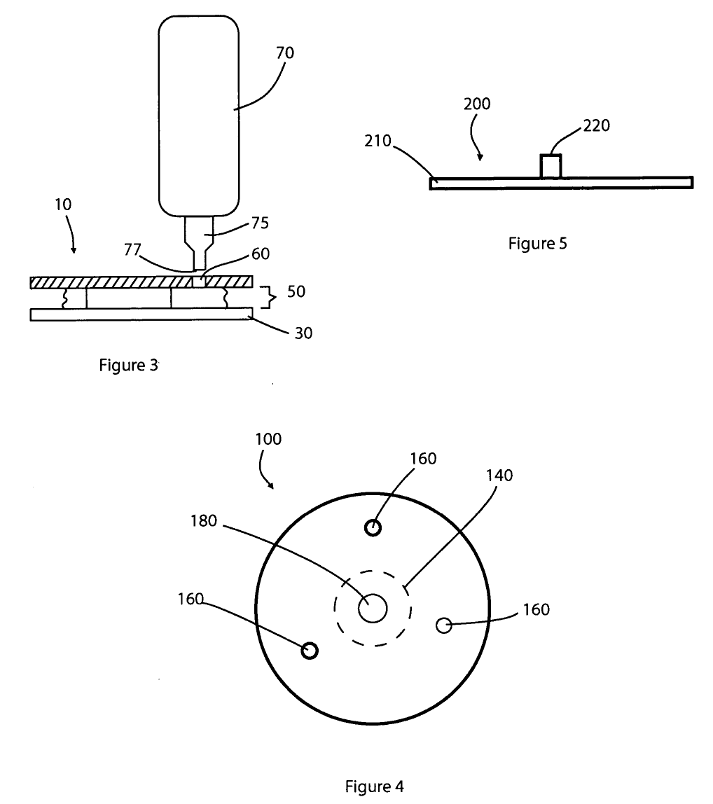

In use the bait station 10 in accordance with the present invention may be filled with any type of liquid bait by injecting the liquid bait into the annular space 50 through apertures 60. Typically, the liquid bait may be injected using a small squeeze bottle 70 as shown in FIG. 3, wherein the squeeze bottle 70 includes a dispensing nozzle 75, wherein the tip 77 of the dispensing nozzle is placed within close proximity of or within one of the apertures 60. By applying a force to the body 72 of the squeeze bottle 70, liquid bait contained within the squeeze bottle is dispensed through an aperture 76 of the dispensing nozzle. As the liquid bait flows from the dispensing nozzle 75 it is received within the annular space 50, due to the capillary action between the liquid bait and the surfaces defining the annular space 50, the liquid bait is retained within the annular space 50. In a preferred embodiment the bait station 10 is generally opaque as described above, thereby allowing a user to readily determine when a sufficient amount of liquid bait had been dispensed into the annular space 50. Once the annular space 50 is filled with a sufficient amount of bait, the now loaded bait dispenser may be placed in a desirable location, wherein the liquid bait will remain within the annular space 50 due to capillary action and fluidic properties of the liquid bait. Alternatively, the bait station may be placed in a desired location, such as an ant trail or the like, and then filled with liquid bait. By placing the bait station first, then filling with liquid bait, the likelihood of spilling the liquid bait is greatly reduced. The liquid bait may be clear in color or may be dyed any color thereby allowing the user to more readily determine if a sufficient amount of bait has been dispensed into the annular space 50 due to the color contract of the bait station and the liquid bait.

It is further contemplated that a retaining means may be disposed on the first surface of the generally circular member 30, wherein the retaining means is configured to retain the bait station on a surface that the bait station has been disposed. Such retaining means may comprise, glues, magnets, high friction surface treatments, or other similar retaining means. It is further contemplated that an aperture may be formed in the generally circular members 120 and 130 and the support column 140 as shown in FIG. 4. By placing an aperture 180 through the center of the bait station 100 a retaining mechanism can then be disposed through the aperture to anchor the bait station to a surface. For example, if the bait station is to be utilized outdoors, it may be desired to anchor the bait station to the ground by disposing an anchor such as a spike through the aperture 80.

Referring now to FIG. 5, there is shown a base 200 to be utilized with the bait station 100 of FIG. 4. The base 200 comprises a generally circular member 210 having first and second surfaces wherein a column 220 extends from the first surface of member 210. The column is generally centered within member 210. Base 200 may further include retention means disposed on the second surface such as those described above. In use, the base 200 would be disposed on a surface, wherein the retention means would be utilized to anchor the base to the surface. The aperture 80 of the bait station 100 would be centered over the column 220 as shown in FIG. 5, wherein the bait station 100 would then be retained by the base 200. The bait station 100 could then be filled with liquid bait as described above.

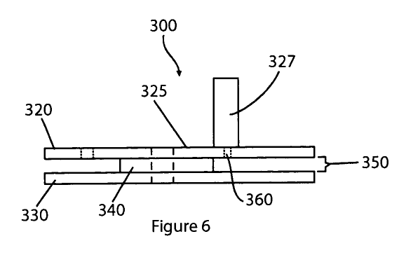

Referring now to FIG. 6, there is shown yet another exemplary embodiment of an alternative design of the bait station 300 in accordance with the present invention. The bait station 300 is constructed similar to that shown in FIGS. 1 and 2, wherein the bait station 300 comprises two generally circular members 320 and 330 spaced apart by a support member 340. The support member 340 creates and annular space 350 between the two generally circular members. As shown in FIG. 6, the generally circular member 320 further includes at least one aperture 360 disposed therethrough, wherein the aperture is in fluid communication with the annular space 350. The generally circular member 320 further includes a fluid column 327. The fluid column 327 extends from the first surface 325 of the circular member 320, wherein the fluid column 327 is disposed over one of the apertures 360. Thus, the fluid column 327 is in fluid communication with the annular space 350. In use, the user fills the bait station 300 with liquid bait. The bait station is filled with liquid bait through the fluid column, wherein the annular space 350 of the bait station fills with liquid bait, wherein the bait is retained within the annular space due to fluid properties and capillary action. In use, as the bait is dispensed from the annular space, fluid within the fluid column flows into the annular space, thereby extending the maintenance period of the bait station 300. Although the present embodiment is shown only having one fluid column 327 it is contemplated that multiple fluid columns may be utilized to extend the maintenance period.

In addition to that described above, the present invention provides an additional benefit wherein the liquid bait disposed within the annular space of the present invention is shielded from evaporating quickly due to minimal exposure to the environment. As shown in FIG. 3 and described above, the liquid bait is only exposed to the environment at the circumference of the dispenser and being defined by the annular space. It is contemplated that distance between the two members which defines the annular space may be adjusted to adjust the evaporation rate of the liquid bait.

In yet another embodiment, it is contemplated that the bait station in accordance with the present invention may include a power source and a radio frequency identification tag (RFID). Wherein after placing the bait station in a desired location, the power source may be energized wherein the RFID tag would transmit a signal that is configured to be received by a receiver, such that the locations of the bait stations may be mapped. By mapping the locations of the bait stations, the level of liquid bait may be checked by anyone who has access to a receiver unit. Additionally, the bait station may further include a fluid level sensor, wherein when the liquid bait is exhausted or nearly exhausted, a transmitter may transmit a signal indicating that the liquid bait needs to be replenished. In addition to or alternative to those systems described above, a visual feedback device such as a light bulb or light emitting device (LED) may be utilized in place of or in conjunction with the transmitter.

In accordance with an alternative method in accordance with the present invention there is provided a method of placing bait stations, wherein the method includes the steps of (1) placing a bait station in a desired location, (2) anchoring the bait station if desired, (3) filling the bait station with bait, and (4) recording the Cartesian coordinates of the bait station with a global positioning device. In accordance with the alternative method, the location of each bait station is recorded with a GPS device, wherein the coordinates may be overlaid on a map of the property, thereby providing the user with a detailed location of each of the bait stations as well as a time stamp of when the bait stations were filled with liquid bait. Having time information may be valuable in determining infestation and/or allow a user to set up a maintenance schedule.

The instant invention is shown and described herein in what is considered to be the most practical, and preferred embodiments. It is recognized, however, that departures may be made there from, which are within the scope of the invention, and that obvious modifications will occur to one skilled in the art upon reading this disclosure.

1. A bait station, the bait station comprising:
a first member;
a second member; and
a support column disposed between and spacing apart said first and second members thereby defining an annular space between said first and second members, wherein one of said first and second members includes at least one aperture formed therethough and in communication with said annular space.

2. The bait station according to claim 1, wherein said first member, said second member and said support column are formed as an integrated member.

3. The bait station according to claim 2, wherein said first member, said second member, and said support column are constructed of a material chosen from the group consisting of: plastic, polycarbonates, polyvinyl chlorides, composites, metals, nylon, urethane.

4. A bait station kit, said kit comprising:
a bait station according to claim 1; and
a bottle of liquid bait.

5. The bait station according to claim 1, wherein the first and second members and support column are constructed of a resilient material.

6. The bait station according to claim 1, wherein said first member is constructed to include a portion of said support column, and said second member is constructed to receive a second portion of said support column, wherein each of said support column portion is configured to be joined together.

7. The bait station according to claim 1, wherein said first member, said second member and said support column are constructed of the same material.

8. The bait station according to claim 1, wherein said first member and said second member are constructed of the same material.

9. The bait station according to claim 1, further including a second aperture disposed through said first and second members and in axial alignment with the support column.

10. The bait station according to claim 9 wherein said first and second members are generally circular in shape.

11. The bait station according to claim 1, wherein said first and second members and said support column are formed as an integrated unit.

12. The bait station according to claim 1, wherein said planer members and said support column are formed of individual pieces and are assembled to form a bait station.

13. A bait station, said bait station comprising:
a first generally circular planar member having first and second surfaces;
a second generally circular planar member having first and second surfaces;
a support member disposed between said second surfaces of said planar members, thereby creating an annular space between the second surfaces of said planar members; and
at least one aperture formed in one of said planer members, wherein said aperture is in fluid communication with said annular space.

14. The bait station according to claim 13, further including an aperture disposed through said planer members and said support member.

15. The bait station according to claim 13, said bait station further including a fluid chamber extending from the first surface of the planer member having the aperture formed therein, whereby said fluid chamber is in fluid communication with said annular space.

16. The bait station according to claim 12, wherein said individual pieces are constructed by injection molding.

17. The bait station according to claim 1, wherein the bait station further includes a magnet associated with an outer surface of either the first or second member.

18. The bait station according to claim 1, further including a second column, said second column extending from a surface of one of the first or second members.

19. The bait station according to claim 18, wherein the second column is in fluid communication with the annular space formed between the first and second members.

20. The bait station according to claim 1, wherein said annular space is configured to minimize evaporation of liquid bait disposed therein.
